(19) United States
(12) Patent Application Publication
(10) Pub. No.: US 2015/0093668 A1
(43) Pub. Date: Apr. 2, 2015

(54) FUEL CELL SYSTEM

(71) Applicant: BROTHER KOGYO KABUSHIKI KAISHA, Nagoya-shi (JP)

(72) Inventor: Yoshiaki Fukatsu, Hekinan-shi (JP)

(73) Assignee: BROTHER KOGYO KABUSHIKI KAISHA, Nagoya-shi (JP)

(21) Appl. No.: 14/228,787

(22) Filed: Mar. 28, 2014

(30) Foreign Application Priority Data
Sep. 30, 2013 (JP) 2013-205088
Feb. 28, 2014 (JP) 2014-038029

(51) Int. Cl. H01M 8/04

(52) U.S. Cl. CPC H01M 8/04753; H01M 8/04104; H01M 8/04552; H01M 8/04559; H01M 8/04761; H01M 2008/1095
USPC 429/432

(57) ABSTRACT

A fuel cell system may comprise: a fuel cell including an anode electrode, a cathode electrode and a polymeric membrane; a first valve configured to supply a material to anode electrode; a second valve configured to discharge gas from anode electrode; a third valve configured to supply a material to cathode electrode; a fourth valve configured to discharge gas from the cathode electrode; a fifth valve configured to supply a material to the anode electrode; a voltage measurement unit configured to measure voltage of the fuel cell system; and a controller. The controller may be configured to: instruct the first valve, third valve, and fourth valve to be in the closed state; instruct the second valve and fifth valve to be in the open state; acquire a voltage value from the voltage measurement unit after instructing these valves; and determine whether the voltage value satisfies a predetermine condition.

### CROSS-REFERENCE TO RELATED APPLICATIONS

This non-provisional application claims priority under 35 U.S.C. §119(a) on Patent Applications No. 2013-205088 filed in Japan on Sep. 30, 2013, and No. 2014-038029 filed in Japan on Feb. 28, 2014, the entire contents of which are hereby incorporated by reference.

### TECHNICAL FIELD

The present disclosure relates to a fuel cell system capable of detecting fuel gas leakage detection and a method of detecting fuel gas leakage.

### BACKGROUND

A polymer type fuel cell system including an anode electrode and a cathode electrode that sandwich a polymeric membrane through which hydrogen ions pass and configured to generate an electromotive force by electrochemical reaction between fuel gas and oxidizing gas is known.

The fuel cell system configured to detect whether fuel gas is leaking based on a voltage drop speed after stoppage of the fuel cell system is proposed.

### SUMMARY

In the conventional fuel cell system, after the fuel cell system is executed, when a connection between an external load and the fuel cell system is disconnected, the fuel gas and the oxidizing gas are stopped to supply. When a drop speed of a voltage is extremely high and the fuel gas and the oxidizing gas are stopped, the fuel cell system determines that the fuel gas is leaking. For example, when the fuel cell system is stopped to generate power source in a state of emergency, the fuel cell system discharges the fuel gas to outside of the fuel cell system. In this case, the conventional method does not determine whether the fuel gas is leaking or not.

Accordingly, the present disclosure is provided a fuel cell system and a method which determines whether a fuel gas is leaking or not, even though the fuel cell system discharges the fuel gas to outside of the fuel cell system.

Aspects described herein may provide a fuel cell system which may comprise: a fuel cell including an anode electrode, a cathode electrode, and a polymeric membrane having ion permeability; a first valve configured to be switchable in an open state or in a closed state according to an electronic signal for supplying a first material including hydrogen to the anode electrode; a second valve configured to be switchable in an open state or in a closed state according to an electronic signal for discharging gas from the anode electrode; a third valve configured to be switchable in an open state or in a closed state according to an electronic signal for supplying a second material including oxygen to the cathode electrode; a fourth valve configured to be switchable in an open state or in a closed state according to an electronic signal for discharging gas from the cathode electrode; a fifth valve configured to be switchable in an open state or in a closed state according to an electronic signal for supplying a third material including oxygen to the anode electrode; a voltage measurement unit configured to measure voltage between the anode electrode and the cathode electrode; and a controller. The controller is configured to: transmit a first electronic signal to the first valve, the third valve and the fourth valve, the first electronic signal being for instructing the first valve, the third valve and the fourth valve to be in the closed state; transmit a second electronic signal to the second valve and the fifth valve, the second electronic signal being for instructing the second valve and the fifth valve to be in the open state; acquire a voltage value from the voltage measurement unit after transmitting both of the signals; and determine whether the voltage value satisfies a predetermine condition.

According to other aspects may provide a method of detecting fuel gas leakage to detect leakage of a fuel gas of a fuel cell system which may comprise: a fuel cell including an anode electrode, a cathode electrode, and a polymeric membrane having ion permeability; a first valve configured to be switchable in an open state or in a closed state according to an electronic signal for supplying a first material including hydrogen to the anode electrode; a second valve configured to be switchable in an open state or in a closed state according to an electronic signal for discharging gas from the anode electrode; a third valve configured to be switchable in an open state or in a closed state according to an electronic signal for supplying a second material including oxygen to the cathode electrode; a fourth valve configured to be switchable in an open state or in a closed state according to an electronic signal for discharging gas from the cathode electrode; a fifth valve configured to be switchable in an open state or in a closed state according to an electronic signal for supplying a third material including oxygen to the anode electrode; and a voltage measurement unit configured to measure voltage between the anode electrode and the cathode electrode. The method may comprise a step of transmitting a first electronic signal to the first valve, the third valve, and the fifth valve, the first electronic signal being for instructing the first valve, the third valve and the fourth valve to be in the closed state. The method may comprise a step of transmitting a second electronic signal to the second valve and the fifth valve, the second electronic signal being for instructing the second valve and the fifth valve to be in the open state. The method may comprise a step of acquiring a voltage value from the voltage measurement unit after transmitting both of the signals. The method may comprise a step of determining whether the voltage value satisfies a predetermine condition.

### BRIEF DESCRIPTION OF THE SEVERAL VIEWS OF THE DRAWINGS

FIG. 1 is an example of a schematic view showing an embodiment of a fuel cell system of the present disclosure;

FIG. 2 is an example of a drawing of electrical configurations;

FIG. 3A is a flowchart showing an example of control processing related to detection of fuel gas leakage upon stoppage of a fuel cell system;

FIG. 3B is a flowchart showing an example of control processing related to detection of fuel gas leakage upon stoppage of a fuel cell system;

FIG. 4A is a flowchart showing an example of control processing related to detection of fuel gas leakage upon starting of the fuel cell system;

FIG. 4B is a flowchart showing an example of control processing related to detection of fuel gas leakage upon starting of the fuel cell system;

FIG. 5 is a time chart showing open and closed states of a valve upon detection of the fuel gas leakage and a graph showing a variation in voltage between an anode and a cathode;

FIG. 6 is a graph showing a measurement result of a voltage between the anode and the cathode of the fuel cell system in which fuel gas leakage of a predetermined value or more is actually measured; and

FIG. 7 is an example of schematic view showing an alternative embodiment of a fuel cell system of the present disclosure.

### DETAILED DESCRIPTION

(Description of Fuel Cell System)

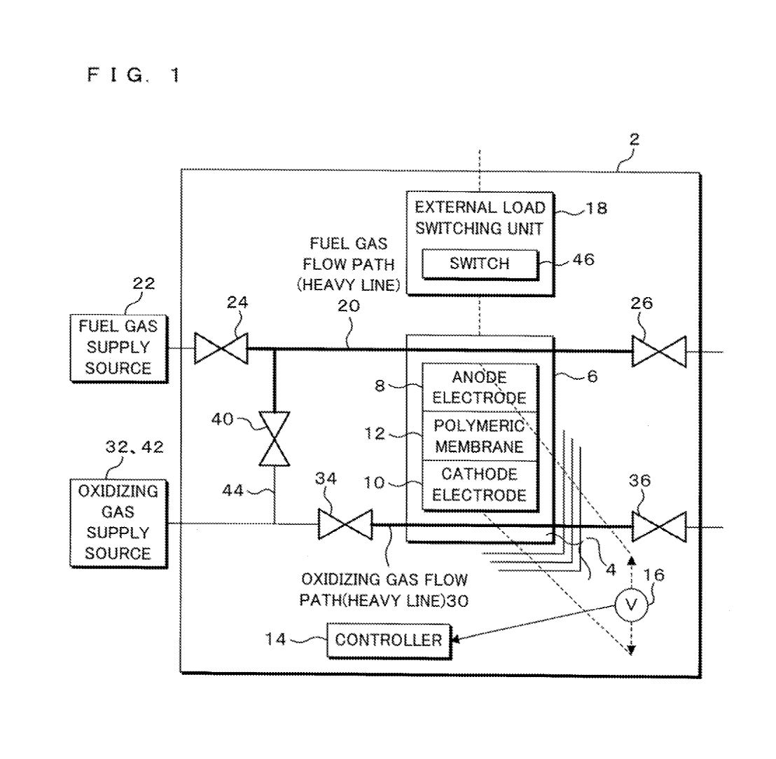

First, an embodiment of a fuel cell system of the present disclosure will be described with reference to FIG. 1.

A fuel cell system 2 of the embodiment includes a fuel cell stack 4, a control part 14, a voltage measurement unit 16, an external load switching unit 18, a fuel gas supply valve 24 (first valve), an oxidizing gas supply valve 34 (third valve), a fuel gas discharge valve 26 (second valve), an oxidizing gas discharge valve 36 (fourth valve), and a substitution gas valve 40 (fifth valve). A fuel gas flow path 20, an oxidizing gas flow path 30, and a substitution gas flow path 44 are formed inside of the fuel cell system 2. Concretely, the fuel gas supply valve 24 and the fuel gas discharging valve 26 may be connected to the fuel cell stack 4 via a tube as the fuel gas flow path 20. The fuel gas flow path 20 may be formed by an inside wall of the fuel cell stack 4. The oxidizing gas supply valve 34 and the oxidizing gas discharging valve 36 may be connected to the fuel cell stack 4 via a tube as the oxidizing gas flow path 30. The oxidizing gas flow path 30 may be formed by an inside wall of the fuel cell stack 4.

The fuel cell stack 4 comprises a plurality of fuel cells 6. The plurality of fuel cells 6 are stacked. The controller 14 is configured to control the fuel cell system 2. The voltage measurement unit 16 is configured to measure a voltage between an anode electrode 8 and a cathode electrode 10 of each of the plurality of the fuel cells 6. The external load switching unit 18 comprises a switch 46 configured to electrically connect or disconnect between the fuel cell stack 4 and an external load. For example, the external load is an external supply destination where the fuel cell system 2 supplies electric power.

Each of the plurality of the fuel cells 6 comprises a polymeric membrane 12 having permeability to ions (for example, hydrogen ions), the anode electrode 8, the cathode electrode 10, an anode-side separator (not shown), and a cathode-side separator (not shown). The anode electrode 8, the polymeric membrane 12 and the cathode electrode 10 are stacked in this order. The anode-side separator is configured to contact with an outer surface of the anode electrode 8, and part of the fuel gas flow path 20 is formed in the anode-side separator. The cathode-side separator is configured to contact with an outer surface of the cathode electrode 10, and part of the oxidizing gas flow path 30 is formed in the cathode-side separator. Each of the plurality of the fuel cells 6 generates electric power by an electrochemical reaction between a fuel gas (for example, hydrogen) supplied to the anode electrode 8 and an oxidizing gas (for example, oxygen in air) supplied to the cathode electrode 10. The fuel gas is one example of first material. The first material may include hydrogen. The oxidizing gas is one example of second material. The oxidizing gas may include oxygen.

The fuel gas is filled in a fuel gas supply source 22. The fuel gas supply source 22 is comprised by, for example, a tank of the fuel gas (for example, hydrogen gas) and supplemental equipment of the tank. The oxidizing gas is filled in an oxidizing gas supply source 32. The oxidizing gas supply source 32 is comprised by, for example, an air pump and supplemental equipment of the air pump. In this embodiment, the oxidizing gas supply source 32 may be an air pump configured to connect to the controller 14 electrically. In this case the controller 14 may control behavior of the air pump using an instruction (or a signal). The oxidizing gas supply source 32 may be operated by a user. In addition, the fuel gas supply source 22 and the oxidizing gas supply source 32 may be other configurations.

Each of the fuel gas supply valve 24, the fuel gas discharge valve 26, the oxidizing gas supply valve 34, the oxidizing gas discharge valve 36, and the substitution gas valve 40 may be a solenoid valves configured to switch between an open state and a closed state based on an instruction (a signal) from, for example, the controller 14. Instead of the solenoid valve, a motor-operated valve configured to switch between the open state and the closed state by a motor may also be used.

Hereinafter, an example of supplying the fuel gas to the anode electrode 8 via the fuel gas flow path 20 will be described. The fuel gas supply valve 24 is disposed between the fuel gas supply source 22 and the fuel gas flow path 20. The fuel gas is supplied the anode electrode 8 of each of the plurality of the fuel cells 6 from the fuel gas supply source 22 via the fuel gas flow path 20, when the fuel gas supply valve 24 is in the open state. On the other hand, the fuel gas is not supplied the anode electrode 8 of each of the plurality of the fuel cells 6 from the fuel gas supply source 22 via the fuel gas flow path 20, when the fuel gas supply valve 24 is in the closed state. Furthermore, the fuel gas supplied from the fuel gas supply source 22 is filled in the fuel gas flow path 20, when the fuel gas discharge valve 26 is in the closed state. On the other hand, gas in the fuel gas flow path 20 is discharged from the fuel cell system 2 to outside of the fuel cell system 2, when the fuel gas discharge valve 26 is in the open state.

Hereinafter, an example of supplying the cathode electrode 10 with the oxidizing gas via the oxidizing gas flow path 30 will be described. The oxidizing gas supply valve 34 is disposed between the oxidizing gas supply source 32 and the oxidizing gas flow path 30. The oxidizing gas is supplied the cathode electrode 10 of each of the plurality of the fuel cells 6 from the oxidizing gas supply source 32 via the oxidizing gas flow path 30, when the oxidizing gas supply valve 34 is the open state. On the other hand, the oxidizing gas is not supplied the cathode electrode 10 of each of the plurality of the fuel cells 6 from the oxidizing gas supply source 32 via the oxidizing gas flow path 30, when the oxidizing gas supply valve 34 is in the closed state. Furthermore, the oxidizing gas supplied from the oxidizing gas supply source 32 is filled in the oxidizing gas flow path 30, when the oxidizing gas discharge valve 36 is in the closed state. On the other hand, gas in the oxidizing gas flow path 30 is discharged from the fuel cell system 2 to outside of the fuel cell system 2, when the oxidizing gas discharge valve 36 is in the open state.

In this embodiment, the fuel cell system 2 comprises the substitution gas valve 40. The substitution gas valve 40 is for substituting the fuel gas filled in the fuel gas flow path 20 with substitution gas (third material). FIG. 1 is an example that the substitution gas is oxidizing gas. For this reason, in FIG. 1, a substitution gas supply source 42 is the same as the oxidizing gas supply source 32. In this embodiment, a substitution gas flow path 44 is connected to the fuel gas flow path 20. More specifically, the substitution gas flow path 44 is disposed between the fuel gas supply valve 24 and the fuel cell stack 4, and the substitution gas flow path 44 is connected to each of the fuel gas supply valve 24 and the fuel cell stack 4.

Hereinafter, an example of supplying the anode electrode 8 with the oxidizing gas as the substitution gas via the substitution gas flow path 44 will be described. The substitution gas valve 40 is disposed between the substitution gas supply source 42 and the substitution gas flow path 44. The oxidizing gas (the substitution gas) is supplied the fuel gas flow path 20 from the oxidizing gas supply source 32 (the substitution gas supply source 42) via the substitution gas flow path 44, and then, the oxidizing gas (the substitution gas) is supplied the anode electrode 8 of each of the plurality of the fuel cells 6 via the fuel gas flow path 20, when the substitution gas supply valve 40 is in the open state. On the other hand, the oxidizing gas (the substitution gas) is not supplied the fuel gas flow path 20 from the oxidizing gas supply source 32 (the substitution gas supply source 42) via the substitution gas flow path 44, and, the oxidizing gas (the substitution gas) is not supplied the anode electrode 8 of each of the plurality of the fuel cells 6 via the fuel gas flow path 20, when the substitution gas supply valve 40 is in the closed state. Furthermore, the oxidizing gas (the substitution gas) supplied from the oxidizing gas supply source 32 (the substitution gas supply source 42) is filled in the fuel gas flow path 20 and the substitution gas flow path 44, when the fuel gas discharge valve 26 is in the closed state. On the other hand, gas in the fuel gas flow path 20 and the substitution gas flow path 44 is discharged from the fuel cell system 2 to outside of the fuel cell system 2, when the fuel gas discharge valve 26 is in the open state. As described above, the gas in the fuel gas flow path 20 is substituted with the oxidizing gas (the substitution gas), when the controller 14 instructs the substitution gas valve 40 to be in the open state, and instructs the fuel gas discharge valve 26 to be in the closed state.

The substitution gas is filled in the substitution gas supply source 42. The substitution gas supply source 42 is comprised by for example, an air pump and supplemental equipment of the air pump. In this embodiment, the substitution gas supply source 42 may be an air pump configured to connect to the controller 14 electrically. In this case the controller 14 may control behavior of the air pump using an instruction (or a signal) which is transmitted from the controller 14. The substitution gas supply source 42 may be operated by a user. In addition, substitution gas supply source 42 may be other configurations. The substitution gas may include oxygen.

The controller 14, for example, comprises one or more of Central Processing Unit (CPU) and Random Access Memory (RAM). The controller 14 may comprise multi-core CPU and RAM. Alternatively, the controller 14 may be a specialized circuit board configured to execute an after-mentioned control process. Alternatively, the controller 14 may be a specialized Application Specific Integrated Circuit (ASIC) configured to execute an after-mentioned control process. The controller 14 is configured to control the fuel gas supply or the oxidizing gas supply or the substitution gas supply by transmitting an instruction (or a signal) to each of the fuel gas supply valve 24, the oxidizing gas supply valve 34, the fuel gas discharge valve 26, the oxidizing gas discharge valve 36, and the substitution gas valve 40 for setting the open state or the closed state. Alternatively, the controller 14 controls each of mechanisms of the fuel cell system 2 such as the external load switching unit 18. The controller 14 may transmit an instruction (or a signal) to the fuel gas supply source 22 or the oxidizing gas supply source 32 for driving the fuel gas supply source 22 or the oxidizing gas supply source 32.

Alternatively, the external load switching unit 18 comprises a switch 46. The external load switching unit 18 is configured to switch between electrically connecting the fuel cell stack 4 to the external load and electrically disconnecting the fuel cell stack 4 to the external load by switching switch 46, according to an instruction (or a signal) which is transmitted from the controller 14.

The voltage measurement unit 16 is configured to measure voltage between the anode electrode 8 and a cathode electrode 10 of each of the plurality of the fuel cells 6. However, it is not limited thereto, for example, the voltage between the cathode electrode 10 and the anode electrode 8 of one of the plurality of the fuel cells 6 is measured by the voltage measurement unit 16. The one of the plurality of the fuel cells 6 may be a fuel cell which is easily to leak the fuel gas. The one of the plurality of the fuel cells 6 may be a fuel cell which is stacked at a central portion having the highest temperature.

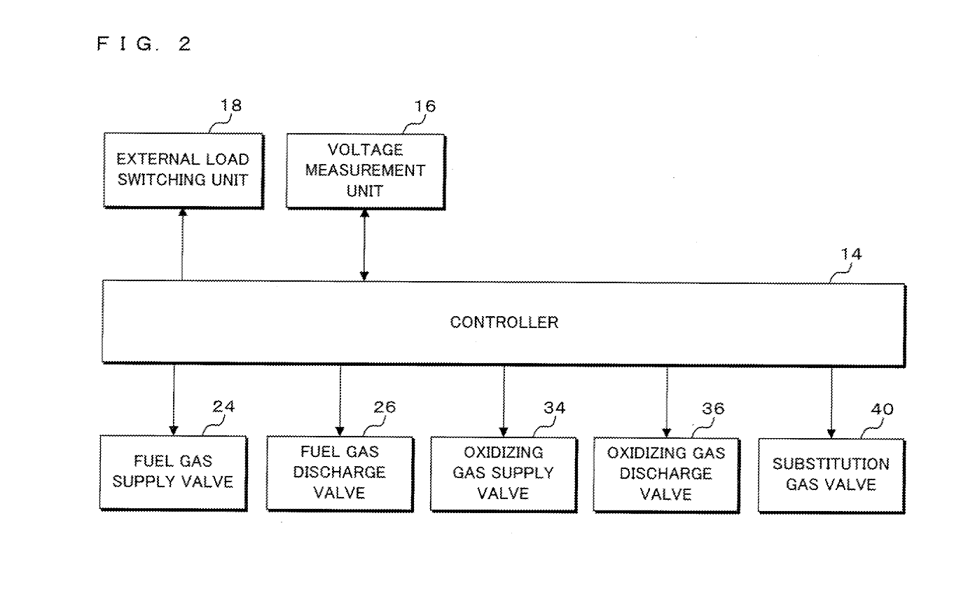

Hereinafter electrical configurations of the fuel cell system 2 will be described with reference to FIG. 2. The controller 14 electrically connects to the voltage measurement 16, the external load switching unit 18, the fuel gas supply valve 24, the oxidizing gas supply valve 34, the fuel gas discharge valve 26, the oxidizing gas discharge valve 36, and the substitution gas valve 40. For this reason, the controller 14 can transmit, to each of the fuel gas supply valve 24, the oxidizing gas supply valve 34, the fuel gas discharge valve 26, the oxidizing gas discharge valve 36, and the substitution gas valve 40, an instruction (or a signal) for setting the open state or the closed state. The controller 14 can acquire a value of the voltage which is measured by the voltage measurement 16. The controller 14 can transmit, to the external load switching unit 18, an instruction (or a signal) for switching the switch 46. For example, the electrical configurations of the fuel cell system 2, such as the controller 14, are driven by electric power which is generated by the fuel cell stack 4. The fuel cell system 2 may comprise a secondary battery (not shown in drawings). The secondary battery may store a given amount of electric power. The secondary battery may supply electric power to the electrical configurations of the fuel cell system 2, such as the controller 14 when the fuel cell system 2 is activated. After activating the fuel cell system 2, each of the plurality of the fuel cells 6 generates electric power, and the generated electric power may be supplied the electrical configurations of the fuel cell system 2 such as the controller 14. The generated electric power may be supplied to the secondary battery, and be stored in the secondary battery.

(Description of Control Processing for Stopping Fuel Cell System)

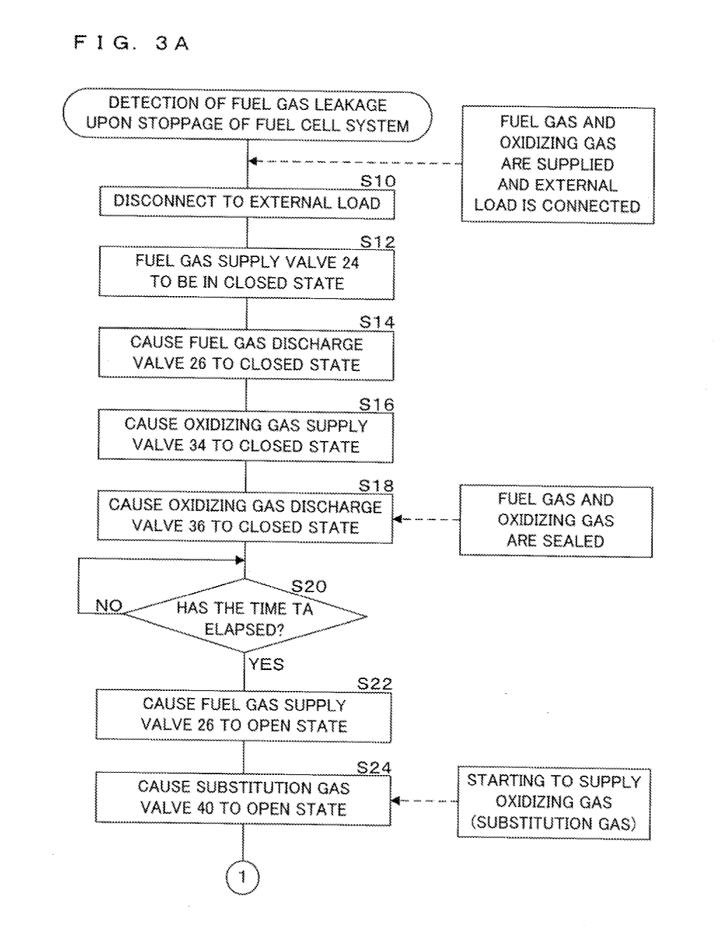

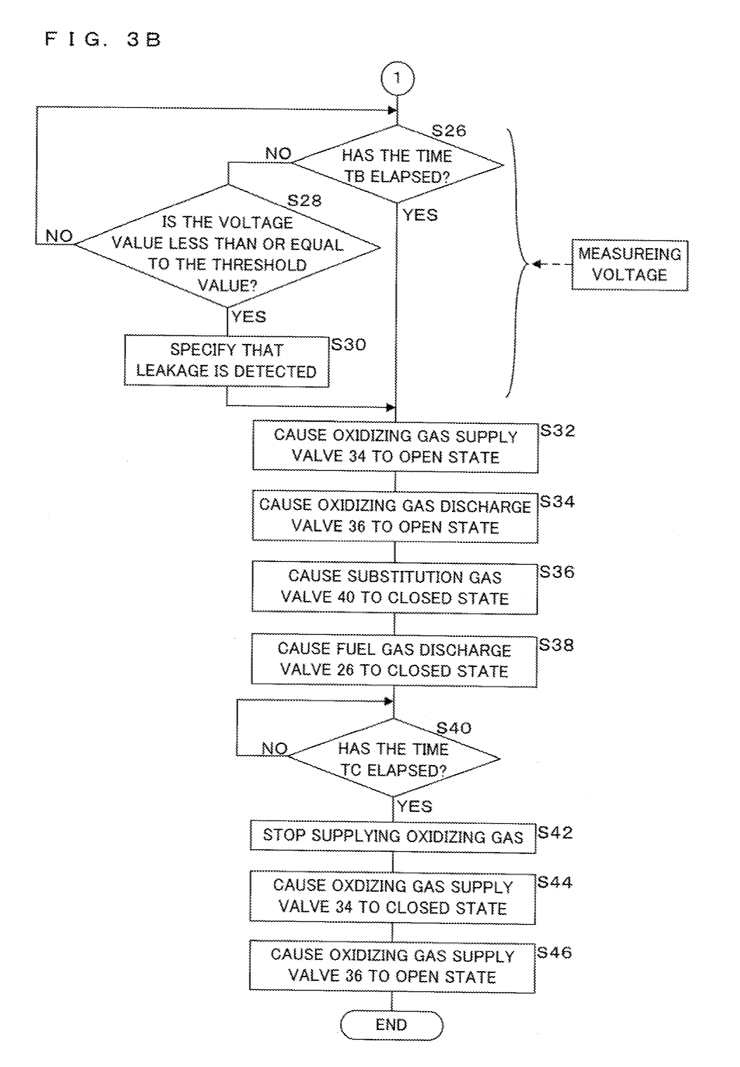

Next, an example of control processing for stopping of the fuel cell system 2 will be described with reference to a flowchart shown in FIG. 3A and FIG. 3B. The flowchart shows the control processing executed by the controller 14.

In this embodiment, when the fuel cell system 2 is activated, the controller 14 instructs the fuel gas supply valve 24, the oxidizing gas supply valve 34 and the oxidizing gas discharge valve 36 to be in the open state. The controller 14 also instructs the fuel gas discharge valve 26 to be in the closed state. The fuel cell stack 4 runs an operating state for generating electric power. During the operating state, the oxidizing gas flows through the oxidizing gas flow path 30 and the fuel gas is filled in the fuel gas flow path 20. That is, the fuel cell stack 4 of the embodiment is a so-called anode dead-end type fuel cell.

In addition, the controller 14 instructs the switch 46 of the external load switching unit 18 to connect to the external load electrically, and the fuel cell stack 4 can supply electric power to the external load. In the operating state, the substitution gas valve 40 is in the closed state. When the fuel cell system 2 runs the operating state, the controller 14 executes the control processing according to the flowchart shown in FIG. 3A and FIG. 3B.

In the operating state, at step S10, the controller 14 transmits an instruction (a signal) to the external load switching unit 18 to turn off the switch 46, and disconnects an electrical connection to the external load (step S10). Next, at step S12, the controller 14 transmits an instruction (a signal) to the fuel gas supply valve 24 for setting the closed state, and causes the fuel gas supply valve 24 to change from the open state to the closed state (step S12).

The fuel cell stack 4 of the embodiment is a so-called anode dead-end type fuel cell in which the fuel gas is filled in the fuel gas flow path 20 during the operating state. That is, basically, the fuel gas discharge valve 26 is in the closed state in the operating state. However, in consideration of the possibility of the fuel gas discharge valve 26 being in the open state due to a certain cause, at step S14, the controller 14 transmits, to the fuel gas discharge valve 26, an instruction (a signal) for setting the closed state, and causes the fuel gas discharge valve 26 to set the closed state (step S14). In this embodiment, the controller 14 is not necessary to execute step S14.

Next, at step S16, the controller 14 transmits, to the oxidizing gas supply valve 34, an instruction (a signal) for setting the closed state and causes the oxidizing gas supply valve 34 to change from the open state to the closed state (step S16). And at step S18, the controller 14 transmits, to the oxidizing gas discharge valve 36, an instruction (a signal) for setting the closed state and causes the oxidizing gas discharge valve 36 to change from the open state to the closed state (step S18). After the controller 14 executes step S12, S14, S16, and S18, the fuel gas is sealed in the fuel gas flow path 20, and the oxidizing gas is sealed in the oxidizing gas flow path 30.

At step S20 the controller 14 determines whether a time TA has elapsed since the controller 14 executed step S18 (at step S20). More specifically, the controller 14 may measure the time by a function of the CPU for measuring time. Here, the time TA may be ten seconds the time TA is not limited thereto. When the controller 14 determines that the time TA has not elapsed (NO at step S20), the controller 14 executes step S20 again. That is, the state in which the fuel gas and the oxidizing gas are sealed is maintained until the controller 14 determines that the time TA has elapsed.

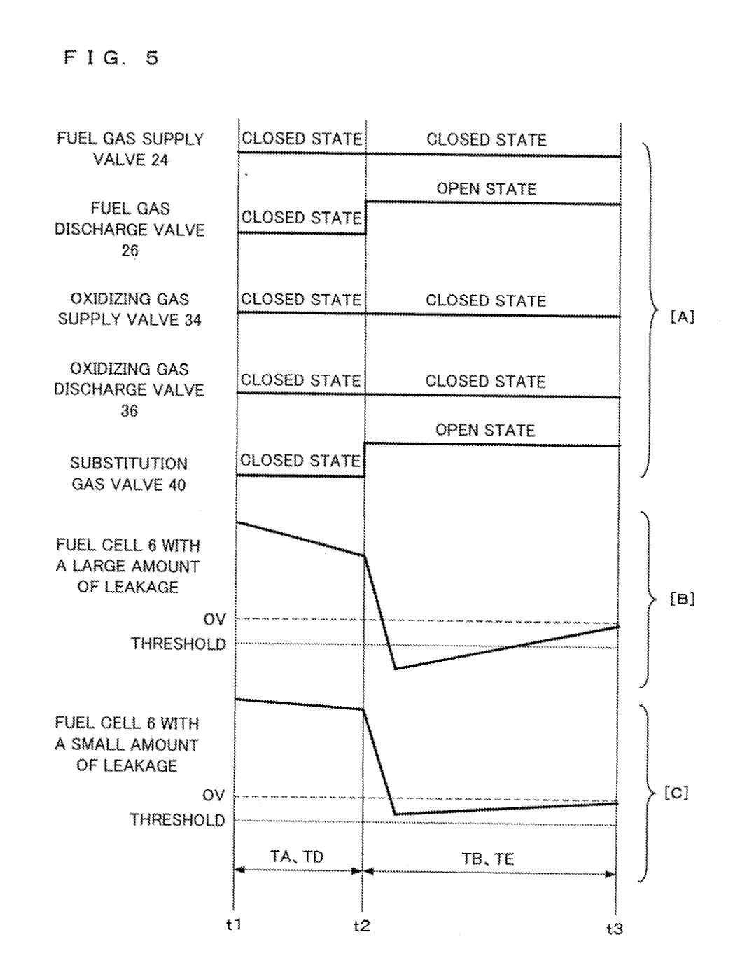

Here, when the voltage between the anode electrode 8 and the cathode electrode 10 of one of the plurality of fuel cells 6 is measured by the voltage measurement unit 16, the measurement values of the voltages are represented as shown in FIG. 5. The voltage between the anode electrode 8 and the cathode electrode 10 in a state in which electrical connection to the external load is disconnected may be referred to as an open circuit voltage (OCV).

In FIG. 5, the horizontal axis is a time axis. A portion [A] of an upper side of FIG. 5 represents a time chart showing the open and closed states of each valve. Portions [B] and [C] of a lower side of FIG. 5 are graphs schematically showing variations in measurement values of the voltage between the anode electrode 8 and the cathode electrode 10. In [B] and [C] of FIG. 5, the vertical axis represents a value of the voltage. [B] of FIG. 5 shows an example of the graph corresponding to one specific fuel cell of the plurality of fuel cells 6 through which a large amount of fuel gas leaks. [C] of FIG. 5 shows an example of the graph corresponding to another specific fuel cell of the plurality of fuel cells 6 through which a small amount of fuel gas leaks. Although the voltage actually varies irregularly in practice, the voltage is schematically represented by a straight line in the time chart. In addition, although the voltage is instantly increased upon electrical disconnection of the external load when the fuel cell system 2 in the operating state is stopped, the variation in voltage after instant increase is schematically represented in FIG. 5. When the fuel cell system 2 is activated, an electrical connection between the fuel cell stack 4 and the external load is disconnected. For this reason, in [B] and [C] of FIG. 5, the cases of stopping and starting of the fuel cell system 2 are schematically represented as the same graph.

During the time TA (from t1 to t2 shown at the bottom of the time chart), the voltage decreases with the passage of time. More specifically, in the one specific fuel cell 6 including the polymeric membrane 12 through which a large amount of fuel gas leaks, the voltage decreases more with the passage of time than another specific fuel cell 6 including the polymeric membrane 12 with a small amount of leakage. In the graph shown in FIG. 5, since a decrease in voltage when the same time elapses is larger in the one specific fuel cell corresponding to the graph [B] of FIG. 5 in which a large amount of fuel gas leaks than the another specific fuel cell corresponding to the graph of [C] of FIG. 5 in which a small amount of fuel gas leaks, an inclination of the graph is increased.

Aside from leakage of the fuel gas, variation in the inclination of the graph can be caused by, for example, a discharge state of water (a clogged state of water) which exists in the flow path formed at the anode-side separator. The water is generated at the cathode electrode 10 side and the generated water is reversely diffused to the anode electrode 8 side via the polymeric membrane 12. The water decreases electric power generation efficiency by preventing contact between the fuel gas and the anode electrode 8. A decrease in electric power generation efficiency is represented as a variation in inclination of the graph.

Returning to the description of the flowchart of FIG. 3A and FIG. 3B, at step S20, when the controller 14 determines that the time TA has elapsed (YES at step S20), at step S22, the controller 14 transmits, to the fuel gas discharge valve 26, an instruction (a signal) for setting the open state, and causes the fuel gas discharge valve 26 to change from the closed state to the open state (step S22). Accordingly, the fuel gas sealed in the fuel gas flow path 20 is discharged from the fuel gas discharge valve 26 to the outside of the fuel cell stack 4, and a pressure of the fuel gas in the fuel gas flow path 20 becomes substantially the same as atmospheric pressure. Next, at step S24, the controller 14 transmits, to the substitution gas valve 40, an instruction (a signal) for setting the open state, and causes the substitution gas valve 40 to change from the closed state to the open state (step S24). Accordingly, the fuel gas in the fuel gas flow path 20 is discharged from the fuel gas discharge valve 26 to the outside of the fuel cell stack 4, and instead of the fuel gas, the oxidizing gas (the substitution gas) is supplied to the fuel gas flow path 20.

After the controller 14 executes step S22 and step S24, the oxidizing gas (the substitution gas) is supplied to the fuel gas flow path 20 in a state in which the pressure of the fuel gas in the fuel gas flow path 20 is reduced to atmospheric pressure.

The fuel gas in the fuel gas flow path 20 is substituted with the oxidizing gas (the substitution gas).

Further, in the above-mentioned embodiment, the controller 14 transmits the instruction (signal) to the substitution valve 40 the instruction (signal) for setting the open state, after the controller 14 transmits the instruction (signal) to the fuel gas discharge valve 26 for setting the open state. The controller 14 may simultaneously transmit the instruction (signal) to the fuel gas discharge valve 26 and the substitution gas valve 40 for setting the open state. The controller 14 may transmit the instruction (signal) to the fuel gas discharge valve 26 for setting the open state, after the controller 14 transmits the instruction (signal) to the substitution valve 40 for setting the open state.

Next, at step S26, the controller 14 determines whether a time TB has elapsed since the controller 14 executed step S22 or step S24(step S26). Here, the time TB is set to a sufficiently large value in comparison with a time needed to substitute the fuel gas exists in the fuel gas flow path 20 with the oxidizing gas (the substitution gas). The time TB may be two minutes, the time TB is not limited thereto. When the controller 14 determines that the time TB has not elapsed (NO at step S26), next, at step S28, the controller 14 determines whether or not the measurement value of the voltage by the voltage measurement unit 16 is less than or equal to a threshold value (step S28). For example, the threshold value is a predetermined negative value. When the controller 14 determines that the measurement value of the voltage is not less than or equal to the threshold value (NO at step S28), the controller 14 returns to step S26 and executes step S26 again.

When the controller 14 determines that the measurement value of the voltage is less than or equal to the threshold value (YES at step S28), at step S30, the controller 14 specifies that leakage of a predetermined amount or more of the fuel gas is detected (step S30), and the controller 14 executes step S32. At step S30, a leakage of a predetermined amount or more represents a leakage of the fuel gas occurs. At step S26, when the controller 14 determines that the time TB has elapsed (YES at step S26), the controller 14 executes step S32.

The measurement values of the voltage between the anode electrode 8 and the cathode electrode 10 of one of the plurality of the fuel cells 6 measured by the voltage measurement unit 16 are shown in the graph of FIG. 5. The voltage is measured by the voltage measurement unit 16 in the time TB, when the oxidizing gas (the substitution gas) is supplied to the fuel gas flow path 20 and the oxidizing gas flow path 30 is sealed. During the time TB (from t2 to t3 shown at a lower end of the chart), in the one specific fuel cell of the graph of [B] of FIG. 5 including the polymeric membrane 12 through which a large amount of fuel gas leaks, after t2 has passed, the voltage abruptly decreases below 0 V. Furthermore, the voltage decreases to be lower than the threshold value, which is a negative value, and the voltage decreases at the lowest point, and then the voltage gradually increases toward 0 V. In this way, when the measurement value of the voltage by the voltage measurement unit 16 is less than or equal to the threshold value, the controller 14 determines that leakage of the fuel gas of a predetermined amount or more occurs. The “leakage of the fuel gas of a predetermined amount or more occurs” means that leakage of the fuel gas is problematic in practice occurs.

Reasons for which the voltage decreases to the threshold value or less are considered as follows.

When the fuel gas passes through the polymeric membrane 12 and leaks, a predetermined amount or more of the fuel gas exists at the cathode electrode 10 side. In this state, when the substitution gas (for example, oxidizing gas) is filled at the anode electrode 8 side, a reverse potential is generated between the fuel gas existing at the cathode electrode 10 side and the oxidizing gas (the substitution gas) existing at the anode electrode 8 side. The reverse potential is represented as a reverse potential with respect to a normal potential when the fuel cell stack 4 normally generates between the anode electrode 8 and the cathode electrode 10 in the operating state. The voltage measurement unit 16 measures a negative value of the voltage, when the reverse potential is generated. On the other hand, the voltage measurement unit 16 measures a positive value of the voltage, when the fuel cell stack 4 normally generates the normal potential in the operating state. Accordingly, the controller 14 determines that the leakage of the fuel gas of the predetermined amount or more occurs, when the voltage measurement unit 16 measures the threshold value or less, because the predetermined amount or more of the fuel gas passes through the polymeric membrane 12 and leaks toward the cathode electrode 10.

Accordingly, as an appropriate threshold value is set, the controller 14 can determine whether or not the leakage of the fuel gas of the predetermined amount or more that is problematic in practice occurs. The threshold value may be a value from −10 mV to −30 mV, the threshold value is not limited thereto. In this embodiment, while the voltage measurement unit 16 measures the voltage between the anode electrode 8 and the cathode electrode 10 of the one of the plurality of fuel cells 6, the voltage measurement unit 16 is not limited thereto.

Even in the another specific fuel cell 6 in which a small amount of fuel gas leaks (leakage of a predetermined amount or more does not occur) as shown in the graph of [C] of FIG. 5, the voltage may decrease below 0 V before the time TB has elapsed from t2. This is because some fuel gas may pass through the polymeric membrane 12 and leak at the cathode electrode 10 side even in a normal fuel cell system 2. However, in the normal fuel cell system 2, because the leakage of the fuel gas is slight, the voltage measurement unit 16 does not measure the threshold value or less.

As described above, the controller 14 controls supply of the substitution gas (for example, the oxidizing gas) to the anode electrode 8. Here, the controller 14 determines whether the voltage measured by the voltage measurement unit 16 is less than or equal to the predetermined value. When the controller 14 determines that the voltage measured by the voltage measurement unit 16 is less than or equal to the predetermined value, the controller 14 can execute a specifying processing for specifying that the leakage of the predetermined amount or more of the fuel gas occurs via the polymeric membrane 12. Accordingly, the controller 14 can determine whether or not the leakage of the predetermined amount or more of the fuel gas occurs via the polymeric membrane 12.

Further, the voltage measurement unit 16 may always measure the voltage between the anode electrode 8 and the cathode electrode 10. The voltage measurement unit 16 may measure the voltage between the anode electrode 8 and the cathode electrode 10 at least during the time TB.

At step S30, the controller 14 determines that the leakage of the fuel gas of the predetermined amount or more occurs, the controller 14 can execute a specific control processing according to the determination result. For example, the controller 14 can provide an alarm based on sound, light, a display, and so on, or can execute the specific control processing such as interlocking such that the fuel cell stack 4 is not re-activated.

Next, at step S32, the controller 14 transmits, to the oxidizing gas supply valve 34, an instruction (a signal) for setting the open state, and causes the oxidizing gas supply valve 34 to change from the closed state to the open state (step S32). At step S34, the controller 14 transmits, to the oxidizing gas discharge valve 36, an instruction (a signal) for setting the open state, and causes the oxidizing gas discharge valve 36 to change from the closed state to the open state (step S34).

After the controller 14 executes S32 and step S34, the oxidizing gas is supplied to the oxidizing gas flow path 30. Accordingly, gas (the gas may also be mixed with the fuel gas and the oxidizing gas) in the oxidizing gas flow path 30 is discharged to the outside of the fuel cell system 2 via the oxidizing gas discharge valve 36, the oxidizing gas is supplied to the oxidizing gas flow path 30. Accordingly, since the fuel gas in the oxidizing gas flow path 30 is discharged to the outside of the fuel cell system 2, a negative voltage value is changed to approximately 0 V as shown in [B] or [C] of FIG. 5.

Next, the controller 14 transmits, to the substitution gas valve 40, an instruction (a signal) for setting the closed state, and causes the substitution gas valve 40 to change from the open state to the closed state (step S36). The controller 14 transmits, to the fuel gas discharge valve 26, an instruction (a signal) for setting the closed state, and causes the fuel gas discharge valve 26 to change from the open state to the closed state (step S38). After the controller 14 executes step S36 and step S38, the oxidizing gas (the substitution gas) is stopped to supply to the fuel gas flow path 20.

After that, at step S40, the controller 14 determines whether a time TC has elapsed since the controller 14 executed step S38 (step S40). Here, the time TC may be 10 seconds, the time TC is not limited thereto. When the controller 14 determines that the time TC has not elapsed (NO at step S40), the controller 14 repeats step S40. That is, during the time TC, a state in which the fuel gas flow path 20 is sealed and the oxidizing gas is supplied to the oxidizing gas flow path 30 is maintained. During the time TC, the voltage value of the negative value approaches approximately 0 V.

When the controller 14 determines that the time TC has elapsed (YES at step S40), at step S42, the controller 14 transmits, to the oxidizing gas supply source 32, an instruction (a signal) for stopping to supply the oxidizing gas and causes the oxidizing gas supply source 32 to stop to supply the oxidizing gas (step S42).

Next, at step S44 the controller 14 transmits, to the oxidizing gas supply valve 34, an instruction (a signal) for setting the closed state and causes the oxidizing gas supply valve 34 to change from the open state to the closed state (step S44). At step S46 the controller 14 transmits, to the oxidizing gas discharge valve 36, an instruction (a signal) for setting the closed state and causes the oxidizing gas discharge valve 36 to change from the open state to the closed state (step S46). After the controller 14 executes step S44 and step S46, the fuel cell stack 4 stops. Accordingly, the controller 14 terminates the control processing shown in FIG. 3A and FIG. 3B.

(Description of Control Processing in Activating Fuel Cell System)

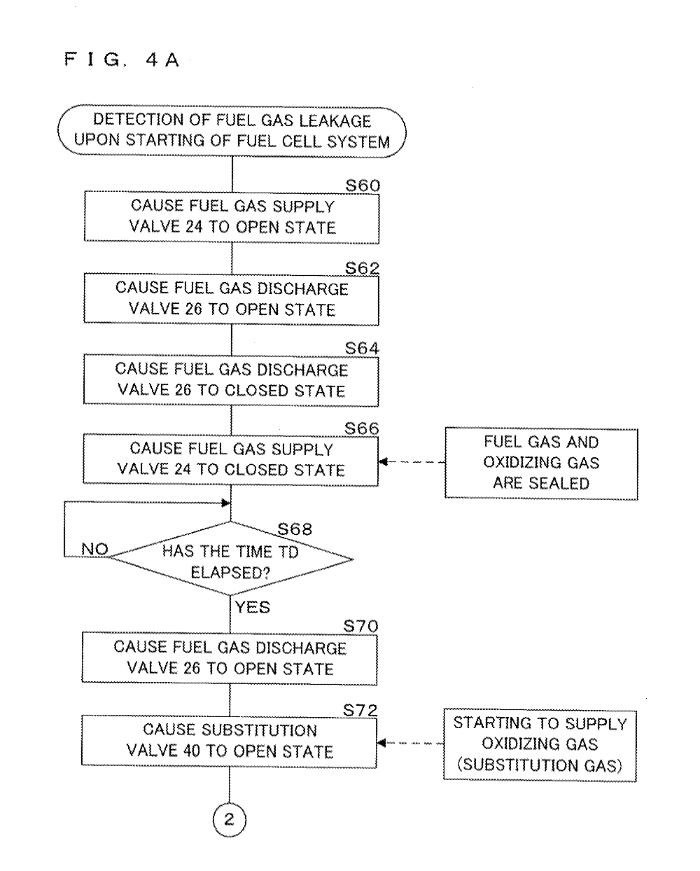

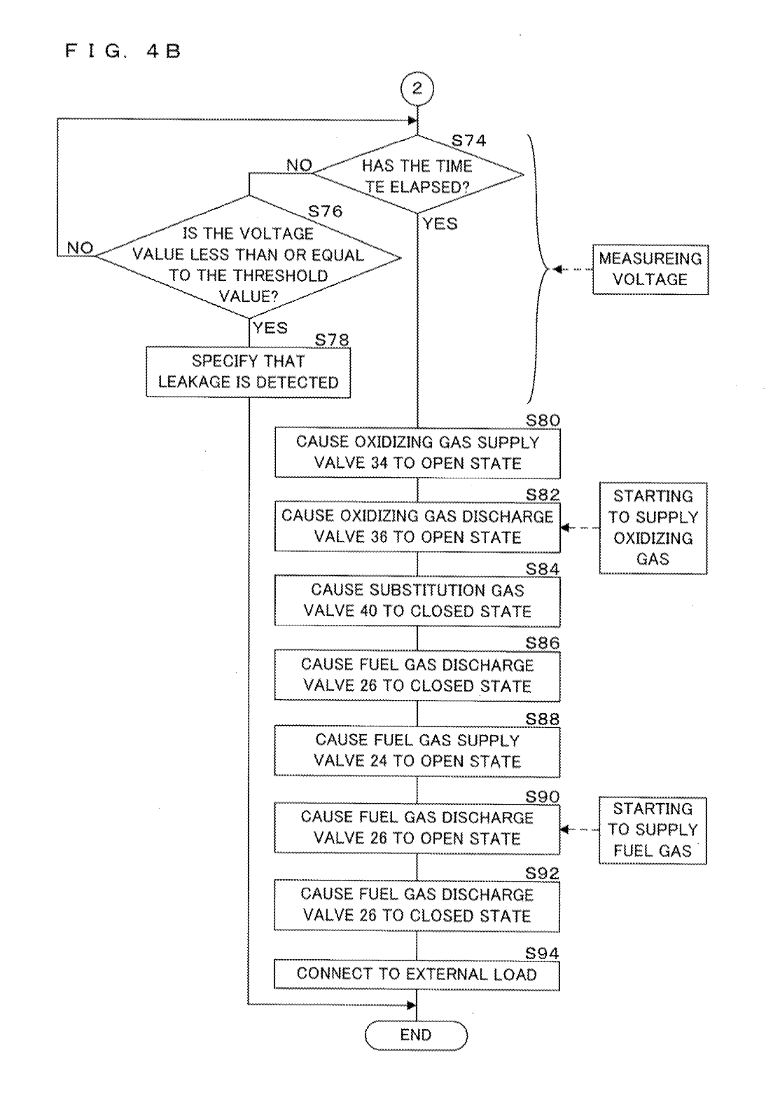

Next, an example of the control processing in activating the fuel cell stack 4 will be described with reference to a flowchart shown in FIG. 4A and FIG. 4B. The flowchart also shows the control processing executed by the controller 14, when the fuel cell system 2 activates.

In this embodiment, when the fuel cell system 2 stops, all of the fuel gas supply valve 24, the fuel gas discharge valve 26, the oxidizing gas supply valve 34, the oxidizing gas discharge valve 36 and the substitution gas valve 40 are closed. In addition, the switch 46 is turned off, and the electrical connection between the external load and the fuel cell stack 4 is disconnected. The controller 14 executes the flowchart shown in FIG. 4A and FIG. 4B, when the fuel cell system 2 activates. In other words, the controller 14 executes the flowchart shown in FIG. 4A and FIG. 4B, when the fuel cell system 2 changes from a stoppage state of the fuel cell system 2 to an activation state.

The controller 14 transmits, to the fuel gas supply valve 24, an instruction (a signal) for setting the open state, and causes the fuel gas supply valve 24 to change from the closed state to the open state (step S60). And then the controller 14 transmits, to the fuel gas discharge valve 26, an instruction (a signal) for setting the open state, and causes the fuel gas discharge valve 26 to change from the closed state to the open state (step S62). Accordingly, after the controller 14 executes step S60, the fuel gas is supplied to the fuel gas flow path 20. The controller 14 transmits, to the fuel gas discharge valve 26, an instruction (a signal) for setting the closed state, and causes the fuel gas discharge valve 26 to change from the open state to the closed state (step S64). The controller 14 transmits, to the fuel gas supply valve 24, an instruction (a signal) for setting the closed state, and causes the fuel gas supply valve 24 to change from the open state to the closed state (step S66). After the controller 14 executes step S64 and step S66, the fuel gas is sealed in the fuel gas flow path 20.

At step S68, the controller 14 determines whether a time TD has elapsed since the controller 14 executed step S66. Similar to the time TA, the time TD may be ten seconds, the time TD is not limited thereto. When the controller 14 determines that the time TD has not elapsed (NO at step S68), the controller 14 repeats step S68. That is, during the time TD, a state in which the fuel gas is sealed in the fuel gas flow path 20 is maintained.

At step S68, when the voltage measured between the anode electrode 8 and the cathode electrode 10 of the one of the plurality of fuel cells 6 by the voltage measurement unit 16, similar to the above-mentioned at step S20, results of the measuring the voltage are same as [B] or [C] of FIG. 5. Since a decrease in voltage when the same time elapses is larger in the one specific fuel cell corresponding to the graph of [B] of FIG. 5 in which a large amount of fuel gas leaks than the another specific fuel cell corresponding to the graph of [C] of FIG. 5 in which a small amount of fuel gas leaks, an inclination of the graph is increased.

When the controller 14 determines that the time TD has elapsed (YES at step S68), next, the controller 14 transmits, to the fuel gas discharge valve 26, an instruction (a signal) for setting the open state, and causes the fuel gas discharge valve 26 to change from the closed state to the open state (step S70). And then, the controller 14 transmits, to the substitution valve 40, an instruction (a signal) for setting the open state, and causes the substitution valve 40 to change from the closed state to the open state (step S72). Accordingly, after the controller 14 executes step S70 and step S72, the fuel gas in the fuel gas flow path 20 is discharged to the outside of the fuel cell system 2 via the fuel gas discharge valve 26, and, the oxidizing gas (the substitution gas) is supplied to the fuel gas flow path 20. After the controller 14 executes step S70 and step S72, the fuel gas in the fuel gas flow path 20 is substituted with the oxidizing gas (the substitution gas).

Next, at step S74, the controller 14 determines whether a time TE has elapsed since the controller 14 executed step S72. Similar to the time TB, the time TE may be two minutes, the time TE is not limited thereto. When the controller 14 determines that the time TE has not elapsed (NO at step S74), next, at step S76, the controller 14 determines whether the measurement value of the voltage by the voltage measurement unit 16 is less than or equal to a threshold value. For example, the threshold value is a predetermined negative value. When the controller 14 determines that the measurement value of the voltage is not less than or equal to the threshold value (NO at step S76), the controller 14 returns to step S74 and executes step S74 again.

When the controller 14 determines that the measurement value of the voltage is less than or equal to the threshold value (YES at step S76), at step S78, the controller 14 specifies that the leakage of a predetermined amount or more of the fuel gas, is detected (step S78). The “leakage of the fuel gas of a predetermined amount or more is detected” means that leakage of the fuel gas occurs. After executing step S78, the controller 14 terminates the control processing in activating the fuel cell system 2. At step S78, the controller 14 can execute a specific control processing. For example, at step S78, the controller 14 can provide an alarm based on sound, a lamp, a display, and so on, or can execute the specific control processing such as interlocking such that the fuel cell stack 4 is not re-activated.

In addition, at step S74, when the controller 14 determines that the time TE has elapsed (YES at step S74), the controller 14 executes step S80.

In this way, the measurement value of the voltage between the anode electrode 8 and the cathode electrode 10 of one of the plurality of fuel cells 6 by the voltage measurement 16 are shown in the graph of FIG. 5 similar to the above-mentioned step S30. The voltage is measured by the voltage measurement unit 16 in the time TD, when the oxidizing gas (the substitution gas) is supplied to the fuel gas flow path 20 and the oxidizing gas flow path 30 is sealed similar to step S30. During the time TD in the one specific fuel cell corresponding to the graph of [B] of FIG. 5 including the polymeric membrane 12 through which a large amount of fuel gas leaks, after t2 has passed, the voltage abruptly decreases below 0 V. Furthermore, the voltage is lowered to the threshold value, which is a negative value and the voltage decreases at the lowest point, and then the voltage gradually increases toward 0 V. In this way, when the measurement value of the voltage by the voltage measurement unit 16 is less than or equal to the threshold value, the controller 14 determines that “leakage of the fuel gas leakage of the fuel gas of a predetermined amount or more occurs.”

Even in the another specific fuel cell in which a small amount of the fuel gas leaks (leakage to a predetermined amount or more does not occur) as shown in the graph of [C] of FIG. 5, the voltage may decrease below 0 V but, the voltage measurement unit 16 does not measure the threshold value or less. Accordingly, when the controller 14 determines that the measurement value of the voltage is less than or equal to the threshold value (YES at step S76), the controller 14 can execute step S78.

In particular, in this embodiment, the controller 14 executes step S76 repeatedly based on the measurement value of the voltage by the voltage measurement unit 16, until the controller 14 determines that the predetermined time (the time TE) has elapsed. Accordingly, the controller 14 can more accurately determine whether or not the leakage of the fuel gas to the predetermined amount or more occurs. In particular, the fuel cell system 2 can execute step S72 in a state in which the fuel gas drops to atmospheric pressure.

Further, the voltage measurement unit 16 may always measure the voltage between the anode electrode 8 and the cathode electrode 10. The voltage measurement unit 16 may measure the voltage between the anode electrode 8 and the cathode electrode 10 at least during the time TE.

After step S80, the controller 14 executes a start procedure of the operation of the fuel cell stack 4, because each of the plurality of fuel cells 6 do not have the leakage of the fuel gas to the predetermined amount or more. First, the controller 14 transmits, to the oxidizing gas supply valve 34, an instruction (a signal) for setting the open state, and causes the oxidizing gas supply valve 34 to change from the closed state to the open state (step S80). And the controller 14 transmits, to the oxidizing gas discharge valve 36, an instruction for setting the open state and causes the oxidizing gas discharge valve 36 to change from the closed state to the open state (step S82). After the controller 14 executes step S80 and step S82, the oxidizing gas is supplied to the oxidizing gas flow path 30. Next, the controller 14 transmits, to the substitution gas valve 40, an instruction (a signal) for setting the closed state, and causes the substitution gas valve 40 to change from the open state to the closed state (step S84). And the controller 14 transmits, to the fuel gas discharge valve 26, an instruction (a signal) for setting the closed state, and causes the fuel gas discharge valve 26 to change from the open state to the closed state (step S86). After the controller 14 executes step S84 and step S86, the oxidizing gas (the substitution gas) is stopped to supply to the fuel gas flow path 20.

Next, the controller 14 transmits, to the fuel gas supply valve 24, an instruction (a signal) for setting the open state, and causes the fuel gas supply valve 24 to change from the closed state to the open state (step S88). And the controller 14 transmits, to the fuel gas discharge valve 26, an instruction (a signal) for setting the open state, and causes the fuel gas discharge valve 26 to change from the closed state to the open state (step S90). After the controller 14 executes step S88 and step S90, the oxidizing gas (the substitution gas) remaining in the fuel gas flow path 20 is discharged to the outside of the fuel cell system 2 via the fuel gas discharge valve 26, and the fuel gas is supplied to the fuel gas flow path 20. The controller 14 transmits, to the fuel gas discharge valve 26, an instruction (a signal) for setting the closed state, and causes the fuel gas discharge valve 26 to change from the open state to the closed state (step S92). In particular, in the so-called anode dead-end type fuel cell which can supply only an amount of a gas consumed by the fuel cell stack 4, the controller 14 may transmit, to the fuel gas discharge valve 26, an instruction (a signal) for setting the closed state, and causes the fuel gas discharge valve 26 to change from the open state to the closed state (step S92), after discharging the oxidizing gas (the substitution gas). Then, at step S94, the controller 14 transmits, to the external load switching unit 18, an instruction (a signal) for turning on the switch 46, and causes the external load switching unit 18 to connect the external load and the fuel cell system 2 electrically (step S94). Accordingly, the fuel cell stack 4 can start to activate. The controller 14 terminates the control processing in activating the fuel cell system 2.

(Description of Method of Detecting Leakage of Fuel Gas)

In the flowcharts shown in FIG. 3A, FIG. 3B, FIG. 4A and FIG. 4B, the control processing executed by the controller 14 are shown, the control processing is not limited thereto. For example, a voltage between the anode electrode 8 and the cathode electrode 10 may be measured using a separate measurement apparatus, which is not included in the fuel cell system 2. A process related to detection of the fuel gas leakage may be executed using a controller separate from the fuel cell system 2. In addition, based on the measurement value of the voltage between the anode electrode 8 and cathode electrode 10, a user may perform comparison with the threshold value and perform determination related to detection of the leakage of the fuel gas.

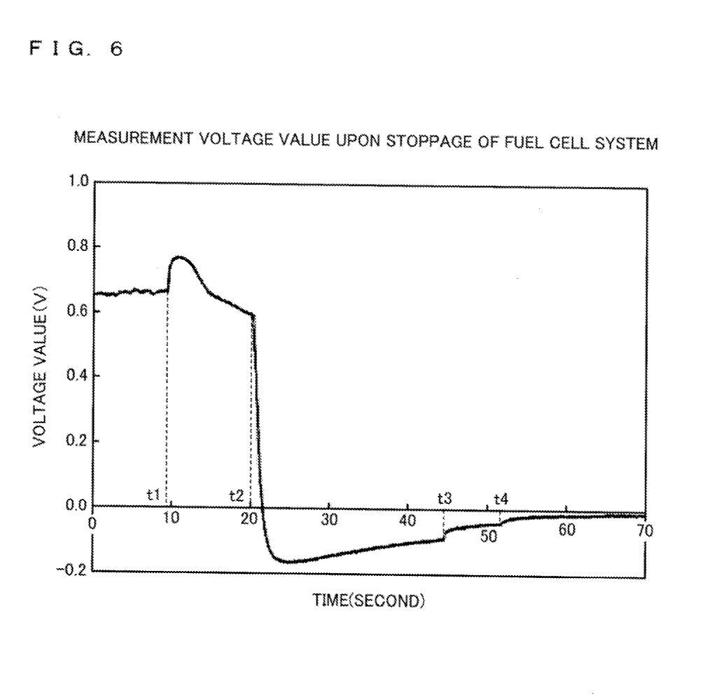

According to the above-mentioned processing, result of measuring the voltages between the anode electrode 8 and the cathode electrode 10 is represented in a graph of FIG. 6. The horizontal axis in FIG. 6 represents a time, and the vertical axis represents a value of voltage. Characters t1, t2 and t3 shown in the graph represent the same timings as t1, t2 and t3 shown in FIG. 5. The results represent the measurement result for detecting the fuel gas leakage in the stoppage state of the fuel cell stack 4.

At t1, when the electrical connection between the fuel cell stack 4 and the external load is disconnected (e.g., at step S10), the voltage between the anode electrode 8 and the cathode electrode 10 instantly increases, and then gradually decreases between t1 and t2 during the time TA (e.g., steps S12, S14, S16, S18 and S20). At t2, after the fuel gas in the fuel gas flow path 20 is substituted with the substitution gas such as the oxidizing gas (e.g., steps S22 and S24), the voltage between the anode electrode 8 and the cathode electrode 10 abruptly decreases below 0 V, decreases to approximately −0.2 V at the lowest point, and then gradually returns to 0 V between t2 and t3 during the time TB (e.g., steps S26, S28, and S30). When the threshold value is set to a value from −10 mV to −30 mV, obviously, the controller 14 may determine that the leakage of the fuel gas to the predetermined amount or more occurs.

At t3, gas in the oxidizing gas flow path 30 is discharged to the outside of the fuel cell system 2 and the oxidizing gas is supplied to the oxidizing gas flow path 30 between t3 and t4 during the time TC (e.g., steps S32, S34, S36, S38 and S40), and then the voltage value approaches approximately 0 V. After all of the fuel gas supply valve 24, the fuel gas discharge valve 26, the oxidizing gas supply valve 34, the oxidizing gas discharge valve 36 and the substitution gas valve 40 are closed (e.g., steps S42, S44 and S46), the measurement value of the voltage becomes approximately 0 V.

As described above, in the above-mentioned embodiment, the controller 14 determines that the leakage of the fuel gas via the polymeric membrane 12 of the predetermined amount or more occurs, when the controller 14 determines that the measurement value of the voltage is less than or equal to the predetermined. In particular, after the controller 14 controls to supply the oxidizing gas (the substitution gas) to the anode electrode 8, the controller 14 executes a determination process for determine whether the leakage of the fuel gas to the predetermined amount or more occurs repeatedly based on the measurement value of the voltage by the voltage measurement unit 16, until the controller 14 determines that the predetermined time (the time TB or TE) has elapsed. Accordingly, the controller 14 can more accurately determine whether the leakage of the fuel gas to the predetermined amount or more occurs.

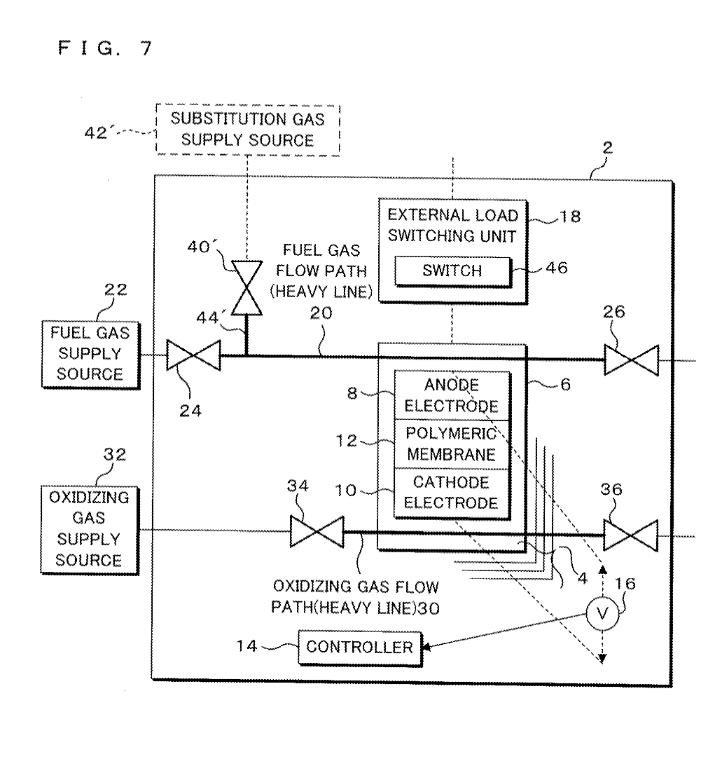

In this embodiment, as shown in FIG. 1, the substitution gas valve 40, the substitution gas supply source 42, and the substitution gas flow path 44 are used, however, the disclosure is not limited to this embodiment. For example, as shown in FIG. 7, the substitution gas valve 40′, the substitution gas supply source 42′, and the substitution gas flow path 44′ may be used. In an example of FIG. 7, the substitution gas supply source 42′ which is different from the oxidizing gas supply source 32 may be used. In FIG. 7, substitution gas supply source 42′ and substitution gas supply valve 44′ may be connected to each other via a tube as substitution gas flow path 44. The substitution gas flow path 44′ may be formed by an inside wall of the fuel cell stack 4. As shown in FIG. 7, the substitution gas flow path 44′ has one end connected to the substitution gas supply valve 40′ and another end connected to the fuel gas flow path 20.

What is claimed is:

1. A fuel cell system, comprising:
a fuel cell including an anode electrode, a cathode electrode, and a polymeric membrane having ion permeability;
a first valve configured to be switchable in an open state or in a closed state according to an electronic signal for supplying a first material including hydrogen to the anode electrode;
a second valve configured to be switchable in an open state or in a closed state according to an electronic signal for discharging gas from the anode electrode;
a third valve configured to be switchable in an open state or in a closed state according to an electronic signal for supplying a second material including oxygen to the cathode electrode;
a fourth valve configured to be switchable in an open state or in a closed state according to an electronic signal for discharging gas from the cathode electrode;
a fifth valve configured to be switchable in an open state or in a closed state according to an electronic signal for supplying a third material including oxygen to the anode electrode;
a voltage measurement unit configured to measure voltage between the anode electrode and the cathode electrode; and
a controller configured to:
transmit a first electronic signal to the first valve, the third valve and the fourth valve, the first electronic signal being for instructing the first valve, the third valve and the fourth valve to be in the closed state;
transmit a second electronic signal to the second valve and the fifth valve, the second electronic signal being for instructing the second valve and the fifth valve to be in the open state;
acquire a voltage value from the voltage measurement unit after transmitting both of the signals; and
determine whether the voltage value satisfies a predetermine condition.

2. The fuel cell system according to claim 1,
wherein to determine whether the voltage value satisfies the predetermine condition, the controller is configured to determine whether the voltage value is equal to or greater than a predetermined voltage value.

3. The fuel cell system according to claim 2,
wherein to determine whether the voltage value satisfies the predetermine condition, the controller is configured to determine whether or not the voltage value is equal to or greater than the predetermined voltage value within a predetermined time after transmitting the second electronic signal.

4. The fuel cell system according to claim 1,
wherein to determine whether the voltage value satisfies the predetermine condition, the controller is configured to determine whether the voltage value represents a negative voltage value.

5. The fuel cell system according to claim 4,
wherein the negative voltage value is equal to or less than a predetermined negative voltage value.

6. The fuel cell system according to claim 5,
wherein to determine whether the voltage value satisfies the predetermine condition, the controller is configured to determine whether the voltage value represents the negative voltage value within a predetermined time after transmitting the second electronic signal.

7. The fuel cell system according to claim 1,
wherein the controller further configured to:
specify that gas leaks via the polymeric membrane in response to determination that the voltage value satisfies a predetermine condition.

8. The fuel cell system according to claim 1, further comprising:
a plurality of the fuel cells;
wherein the first valve is used for supplying the first material to the anode electrode of each of the plurality of the fuel cells;
wherein the second valve is used for discharging gas from the anode electrode of each of the plurality of the fuel cells;
wherein the third valve is used for supplying the second material to the cathode electrode of each of the plurality of the fuel cells;
wherein the fourth valve is used for discharging gas from the cathode electrode of each of the plurality of the fuel cells;
wherein the fifth valve is used for supplying the third material to the anode electrode of each of the plurality of the fuel cells;
wherein the voltage measurement is configured to measure voltage between the anode electrode and the cathode electrode of each of the plurality of the fuel cells;
wherein the controller is configured to acquire, from the voltage measurement unit, a plurality of the voltage values between the anode electrode and the cathode electrode of each of the plurality of the fuel cells; and
wherein to determine whether the voltage value satisfies the predetermine condition, the controller is configured to determine at least one of the plurality of voltage values satisfies a predetermine condition.

9. The fuel cell system according to claim 8,
wherein the controller further configured to:
specify that gas leaks via the polymeric membrane, in response to determination that at least one of the plurality of the voltage values satisfies a predetermine condition.

10. The fuel cell system according to claim 1,
wherein the controller is configured to transmit the second electronic signal after transmitting the first electronic signal.

11. The fuel cell system according to claim 1,
wherein the controller is further configured to:
determine whether the fuel cell system stops supplying electric power to a particular device;
wherein to transmit the first electronic signal, the controller is configured to transmit the first electronic signal in response to a determination that the fuel cell system stops supplying electric power to a particular device; and
wherein to transmit the second electronic signal, the controller is configured to transmit the second electronic signal in response to the determination.

12. A method of detecting fuel gas leakage to detect leakage of a fuel gas of a fuel cell system which comprises:
a fuel cell including an anode electrode, a cathode electrode, and a polymeric membrane having ion permeability;
a first valve configured to be switchable in an open state or in a closed state according to an electronic signal for supplying a first material including hydrogen to the anode electrode;
a second valve configured to be switchable in an open state or in a closed state according to an electronic signal for discharging gas from the anode electrode;
a third valve configured to be switchable in an open state or in a closed state according to an electronic signal for supplying a second material including oxygen to the cathode electrode;
a fourth valve configured to be switchable in an open state or in a closed state according to an electronic signal for discharging gas from the cathode electrode;
a fifth valve configured to be switchable in an open state or in a closed state according to an electronic signal for supplying a third material including oxygen to the anode electrode; and
a voltage measurement unit configured to measure voltage between the anode electrode and the cathode electrode,
the method comprising steps of:
transmitting a first electronic signal to the first valve, the third valve, and the fifth valve, the first electronic signal being for instructing the first valve, the third valve and the fourth valve to be in the closed state;
transmitting a second electronic signal to the second valve and the fifth valve, the second electronic signal being for instructing the second valve and the fifth valve to be in the open state;
acquiring a voltage value from the voltage measurement unit after transmitting both of the signals; and
determining whether the voltage value satisfies a predetermine condition.
